(19) United States
(12) Patent Application Publication
(10) Pub. No.: US 2005/0055258 A1
(43) Pub. Date: Mar. 10, 2005

(54) Method and system for automated freight claims

(76) Inventors: Stephanie Myrick, Austin, TX (US); Janis James, Hutto, TX (US)

Correspondence Address: HAMILTON & TERRILE, LLP, P.O. BOX 203518, AUSTIN, TX, 78720, US

(21) Appl. No.: 10/657,983

(22) Filed: Sep. 9, 2003

(51) Int. Cl. G06F 17/60

(52) U.S. Cl. 705/8

(57) ABSTRACT

Freight claims of a manufacturer to a logistics service provider are automated to manage re-orders of built to order products, such as information handling systems, in response to delivery reports from customers for lost or damaged freight. A freight claim engine automatically initiates communication to the logistics service provider for customer delivery reports of freight claims and determines whether to re-order the delivery of the product based on the response of the logistics service provider. Responses to a freight claim by the logistics service provider that indicate delivery of the product in a desired time precludes a re-build of the product to improve customer satisfaction and reduce manufacturer costs.

### BACKGROUND OF THE INVENTION

1. Field of the Invention

The present invention relates in general to the field of freight delivery, and more particularly to a method and system for automated freight claims for lost or damaged freight.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The great number of different component types and manufacturers used to configure information handling systems allows businesses and individuals tremendous flexibility in configuring information handling systems to meet desired goals and needs. For instance, a business that uses information handling system primarily for secretarial functions, like word processing, may order large numbers of similarly configured systems that have less expensive processing and video components. By comparison, a researcher who performs intense mathematical computations may order a number of different systems tailored to desired functions like processing computations or displaying detailed graphics. An efficient way of taking and filling orders for information handling systems having different configurations is to build the information handling systems to order. In a build-to-order system, customers order information handling systems with desired hardware and software configurations and the systems are built to the ordered configuration after the order is received. Build-to-order systems provide customers with greater flexibility than is available from inventory-based systems in which customers purchase systems already built to configurations that the manufacturer has selected.

One difficulty with build-to-order systems is that information handling systems built to a customer's desired configuration generally must be shipped to the customer's location after they are complete. Specific tracking of information handling systems during the build process to associate systems with orders often presents a complex task. Once an information handling system is built, a logistics service provider, such as FED EX or UPS, typically picks the system up at the manufacturer's factory and delivers the system to the customer according to instructions provided by the manufacturer. The logistics service provider generally has a specified number of days in which to deliver the information handling system to the customer. Mistakes in manufacture or delivery that preclude delivery of an ordered information handling system to a customer are often not discovered until the customer calls to complain that the information handling system did not arrive as scheduled. Typically, information handling system manufacturers are able to track down internal problems that arise prior to delivery of the completed system to the logistics service provider. However, once an information handling system is handed off to the logistics service provider, the manufacturer generally must depend on the provider to track down delivery failures due to limited exchanges of delivery information through firewalls that protect manufacturer proprietary information and customer privacy. If the lost freight cannot be located and delivered to the customer, a new information handling system is usually built and shipped instead. Typically the communication between the manufacturer and logistics service provider takes time so that replacement systems are often built even though the logistics service provider eventually locates lost freight. The building of replacement systems represents a substantial cost, especially where the original system became lost freight due to an error of the manufacturer, such as an incorrect or mislabeled customer address for delivery.

### SUMMARY OF THE INVENTION

Therefore a need has arisen for a method and system which automates information handling system manufacturer and logistic service provider lost freight claims.

A further need exists for a method and system which communicates lost freight claims from a shipper to a logistics service provider in an automated and controlled manner.

In accordance with the present invention, a method and system are provided which substantially reduce the disadvantages and problems associated with previous methods and systems for freight claim management. A freight claim engine automatically communicates freight claims to a logistics service provider and analyzes responses from the logistics service provider to initiate or preclude re-orders of the product associated with the freight claim.

More specifically, the freight claim engine determines freight claims from customer delivery reports received from customers for delivery of built to order information handling systems. A validation engine validates that the delivery location and associated delivery information matches delivery instructions provided to the logistics service provider. A logistics service provider interface communicates the freight claim to the logistics service provider for a response provided within a predetermined time that is monitored by a response time engine. The freight claims engine receives the response and determines the status of the delivery of the information handling system associated with the freight claim. Lost or damaged deliveries, as determined by the response or failure to respond by the logistics service provider, are re-ordered to have a replacement information handling system sent to the customer. Lost deliveries indicated as found by a timely logistics service provider response are precluded from being re-ordered. An accounting engine tracks freight claims and logistic service provider responses to automatically manage financial responsibility of the logistics service provider for lost or damaged freight claims.

The present invention provides a number of important technical advantages. One example of an important technical advantage is that the freight claims engine automates information handling system manufacturer and logistics service provider lost freight claims. By automatically determining freight claims from customer delivery reports and automatically communicating the freight claims to the logistics service provider, the freight claims engine delays the initiation of builds of replacement information handling systems for a period of time to allow the logistics service provider an opportunity to investigate the status of a delivery. If the logistics service provider determines that delivery will occur in a reasonable time, the manufacturer avoids the cost of an additional information handling system build and improves customer satisfaction with a more rapid delivery.

Another example of an important technical advantage of the present invention is that the freight claims engine communicates lost freight claims from a shipper to a logistics service provider in an automated and controlled manner to improve delivery service for a variety of products. Automated communication of selected customer delivery reports as freight claims improves logistics service provider response times to correct product delivery issues. Where deliveries are built to order products, prompt logistics service provider responses to freight claims provides greater manufacturer efficiencies with an informed decision made in a reasonable time of whether to initiate a re-order of the built to order product or to await delivery of an original misdirected product.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a freight claim management system; and

FIG. 2 depicts a flow diagram for freight claim management.

### DETAILED DESCRIPTION

Automated management of freight claims for built to order information handling systems improves customer satisfaction and reduces manufacturing costs by precluding re-orders for lost information handling system deliveries that are found by a logistics service provider. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

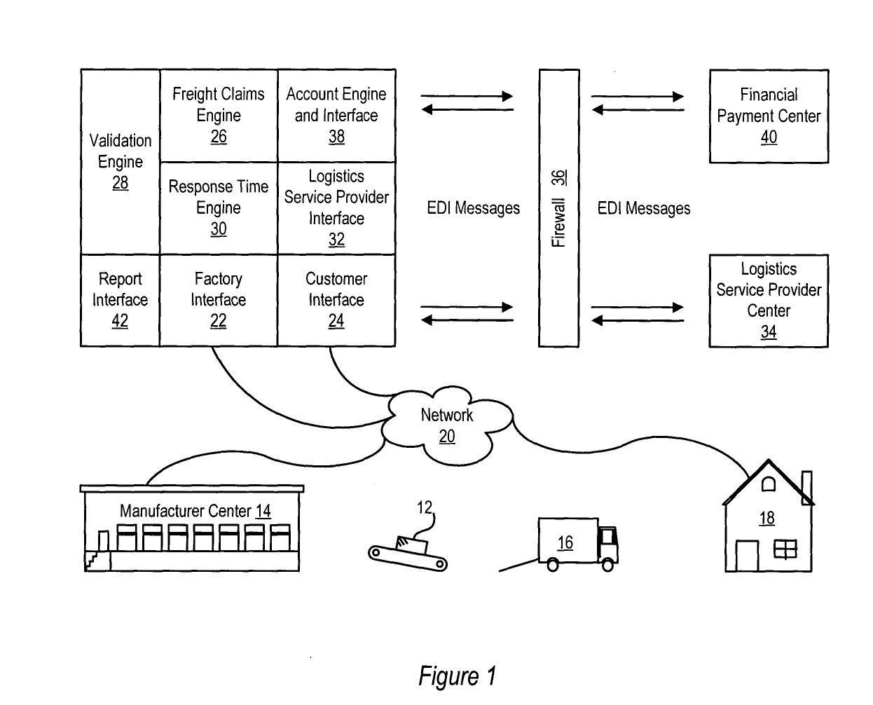

Referring now to FIG. 1, a block diagram depicts a freight claim management system 10 configured to manage freight claims associated with delivery of built to order information handling systems 12. Information handling systems are built in a manufacturer center 14 and shipped by logistics service provider vehicles 16 to a destination location 18, such as a home or business address. The purchase and delivery of information handling system 12 are managed through a network 12, such as by telephone or Internet communications, with the customer of location 18 specifying the configuration and delivery instructions ordered for information handling system 12. Freight management system 12 obtains order and delivery information for built to order information handling systems 12 through a factory interface 22. Customers communicate delivery reports to freight claim management system 10 through a customer interface 24. For instance, delivery reports include delivery of incorrectly configured or damaged information handling systems, and failure to deliver an ordered information handling system in an expected delivery period.

A freight claims engine 26 receives manufacturer center information through factory interface 22 and the customer delivery reports from customer interface 24 to automatically manage freight claims made to the logistics service provider. Freight claims engine 26 may forward all or selected delivery reports to obtain a response from the logistics service provider with the determination of a delivery report as a freight claim based on the urgency of a response and the likelihood of the delivery report involving a logistics service provider error. For instance, a validation engine 28 compares delivery report information with manufacturer center information to identify delivery failures that are likely associated with manufacture errors. Validation engine 28 compares fields populated from the original customer order and fields populated with the delivery report to identify inconsistencies. Examples of fields that are compared or reviewed for validation include product identification information, delivery location information, logistics service provider track information, or shipping date information. As another example, a determination of a delivery report as a freight claim may be based on the likelihood of the resolution of the freight claim with a re-order of the information handling system. If the delivery report, for instance, indicates damage of great severity, then a re-order is a likely resolution and less urgency exists to obtain a response from the logistics service provider.

Freight claims engine 26 reports freight claims to a response time engine 30 for communication to the logistics service provider through a logistics service provider interface 32. Freight claims are communicated by EDI messages to a logistics service provider center 34 with access by the logistics service provider to the information of the information handling system manufacturer restricted by a firewall 36 for security and customer privacy. Logistics service provider 34 performs a trace on the deliveries associated with freight claims to determine the status of the deliveries and reports the status back to freight claims engine 26 through logistics service provider interface 32. Logistics service provider responses approve or deny freight claim financial responsibility. Approved financial responsibility indicates that the delivery was lost or damaged so that freight claim engine 26 may initiate a re-order of the information handling system. Denied financial responsibility requires a denial reason code, proof of delivery, proof of return or projected delivery of the information handling system. Denied financial responsibility indicates that the delivery may still be made and allows freight claims engine 26 to determine based on the denial code whether to initiate a re-order. For instance, proof of delivery with a customer signature may delay a re-order until the claim is investigated for fraud or may result in initiation of a re-order to limit customer delays with actual delivery of the replacement information handling system delayed until the claim is investigated.

Response time engine 30 monitors freight claims and logistics service provider responses to ensure that responses are received in a predetermined time period. Failure to respond to a freight claim by a logistics service provider in the predetermined response time results in an assignment of financial responsibility to the logistics service provider and initiation of a re-order. Freight claims engine 26 provides approved financial claims to an accounting engine and interface 38 which communicates the financial responsibility through EDI messages to a financial payment center 40 responsible for resolving payments between the manufacturer and the logistics service provider. A report interface 42 tracks freight claims to issue status reports for the manufacturer to monitor delivery results. The automated communication of freight claims to the logistics service provider allows for predictable delivery traces without operator intervention so that re-orders of information handling systems may be delayed until a response is received from the logistics service provider without substantial impact on the build time of a replacement information handling system if a replacement becomes necessary. Further, the cost of a re-order may be precluded where the response indicates that the original information handling system has a reasonable likelihood of successful delivery in a predetermined time.

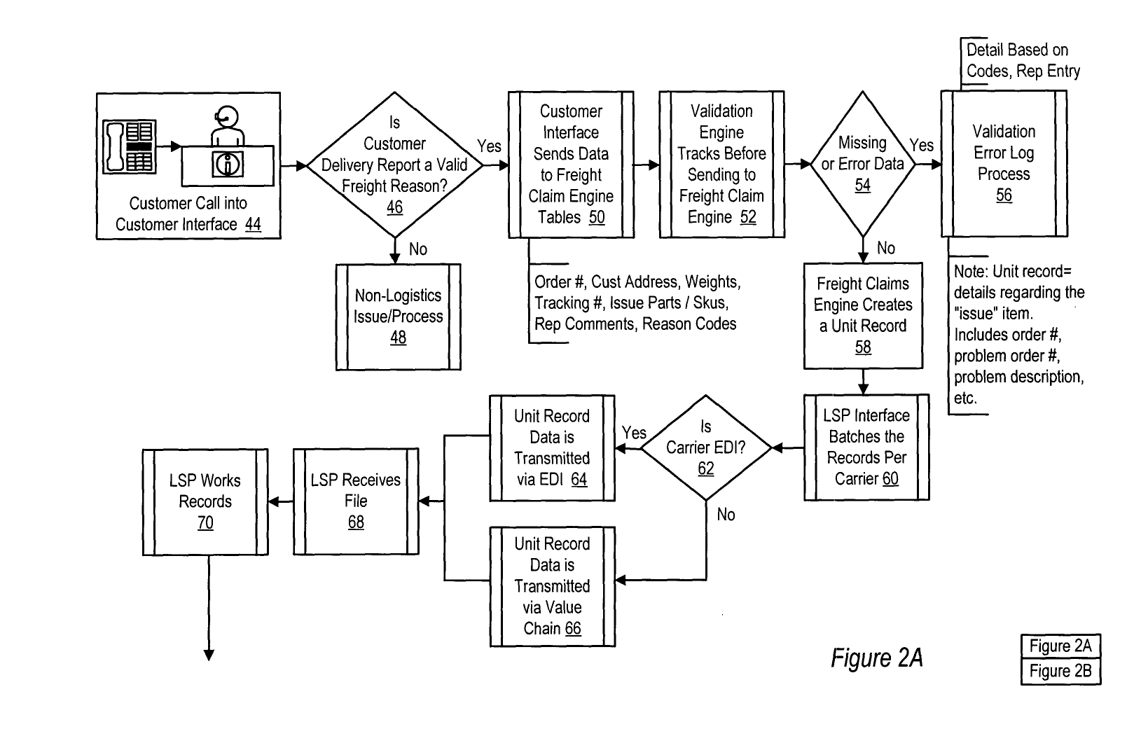

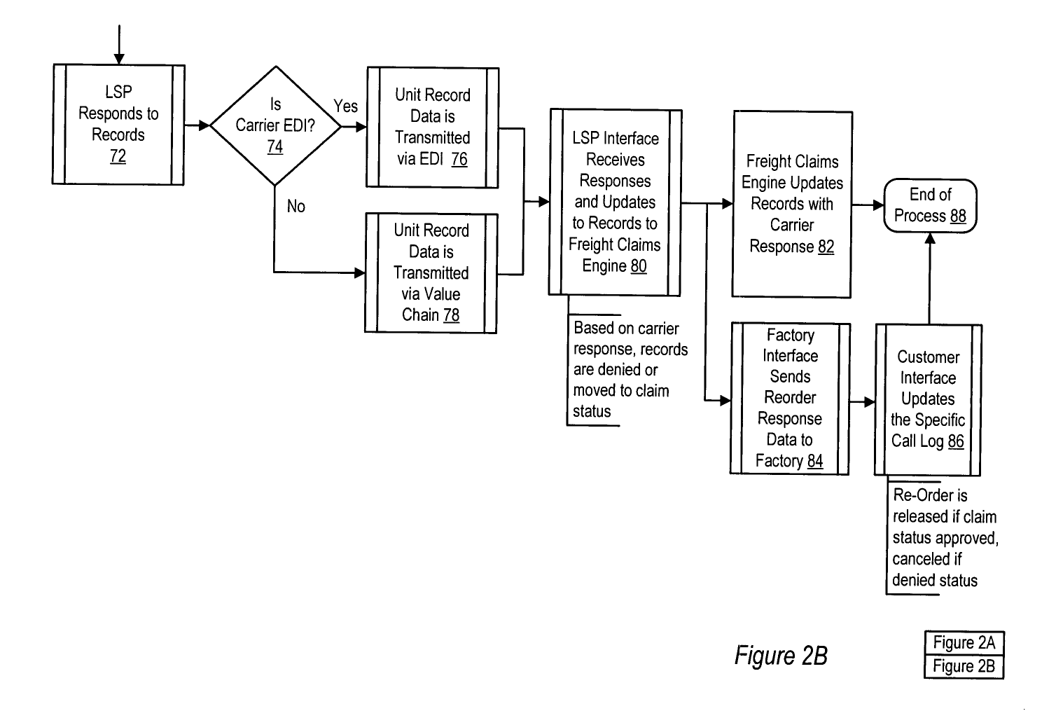

Referring now to FIG. 2, a flow diagram depicts a process for automated freight claims management. The process begins at step 44 with a customer communication of a delivery report to the customer interface, such as by a phone call to a manufacturer customer representative. At step 46 a determination is made of whether the customer delivery report is a valid freight reason. For instance, if the customer call references a missing component in a properly addressed delivery, the delivery report is not considered a freight claim and the process continues to step 48 for handling as a non-logistics issue. If the customer delivery report is determined as a freight claim, such as a failure to deliver an ordered information handling system in an expected time period, the process continues to step 50 for handling as a freight claim with input of delivery report information, such as the order number, customer address, weights, tracking number, SKU or parts number, customer representative comments and reason codes.

At step 52, the validation engine tracks the customer delivery report information for comparison with the original order to information and, at step 54, determines if information is missing or erroneous. If information is missing or erroneous, at step 56 the validation engine logs the error with a red flag for manual handling by a customer care representative. If the information is valid, the process continues to step 58 at which the freight claims engine generates a unit record for the freight claim in a format to allow investigation by the logistics service provider, such as by including the delivery problem, order number and delivery address. At step 60, the logistics service provider interface batches the freight claim for delivery to the logistics service provider. At step 62, a determination is made of whether to communicate the freight claim by EDI message or through a value chain communication medium. If the logistics service provider receives EDI messages, the process continues to step 64 to send the freight claims by EDI message, such as an encrypted EDI 920 file. If the logistics service provider does not receive EDI messages, the process continues to step 66 to send the freight claims by value chain, such as a spreadsheet posted to a secure Web site. At step 68, the logistics service provider receives and decrypts the freight claim and, at step 70 investigates the status of the information handling system delivery associated with the freight claim. At step 72, the logistics service provide responds to the freight claims with approval of the claim or denial and the associated denial information. If the logistics service provider is determined EDI capable at step 74, the process continues to step 76 at which the response is sent to the manufacturer by EDI message, such as an encrypted 141 file. If the logistics service provider is determined not EDI capable at step 74, the process continues to step 78 at which the response is sent to the manufacturer by a value chain message, such as a spread sheet posted to a secured Web site. At step 80, the logistics service provider interface receives the response and updates the freight claims engine record at step 82 so that the freight claims engine may determine the freight claims status as approved or denied based on the response. At step 84, the factory interface sends responses resulting in re-orders to the factory for building of a replacement information handling system. At step 86, the resolution of the freight claim is provided to the customer interface to update the call log of the customer delivery report and respond to the customer as appropriate. The process completes at step 88 with resolution of the freight claim.

Although the present invention has been described in detail, it should be understood that various changes, substitutions and alterations can be made hereto without departing from the spirit and scope of the invention as defined by the appended claims.

1. A system for automated freight claim management of freight deliveries, the system comprising:
a customer interface operable to accept delivery reports from customers;
a freight claim engine operable to automatically process the delivery reports to identify freight claims; and
a logistics service provider interface operable to communicate freight claims to the logistics service provider and to receive logistics service provider responses;
wherein the freight claim engine is further operable to process logistics service provider responses to resolve freight claims.

2. The system of claim 1 wherein the freight claim engine is further operable to resolve freight claims by automatically generating a re-delivery order for logistics service provider responses of lost freight.

3. The system of claim 2 further comprising a response time engine interfaced with the freight claim engine and operable to assign a response of lost freight to a freight claim if the logistics service provider fails to respond to the freight claim in a predetermined time.

4. The system of claim 2 wherein the freight claim engine is further operable to resolve freight claims by automatically precluding a re-delivery order for logistics service provider responses of found freight.

5. The system of claim 2 further comprising an accounting engine interfaced with the freight claims engine and operable to track payment balances to the logistics service provider based on the identified freight claims and the logistics service provider responses.

6. The system of claim 5 wherein the logistics service provider interface comprises an EDI communications interface.

7. The system of claim 1 wherein the deliveries comprise built to order products.

8. The system of claim 7 wherein the built to order products comprise information handling systems.

9. The system of claim 8 further comprising an information handling system order validation engine associated with the freight claims engine and operable to compare information associated with freight claims with one or more required information fields to identify and intercept deficient freight claims from communication to the logistics service provider.

10. The system of claim 9 wherein the freight claims engine generates re-delivery orders for deficient freight claims.

11. A method for automated freight claims management of freight deliveries, the method comprising:
receiving delivery reports from customers;
identifying delivery reports as freight claims by one or more predetermined factors;
automatically communicating freight claims to a logistics service provider associated with the freight deliveries;
receiving responses to the freight claims from the logistics service provider; and
automatically resolving the freight claims according to the logistics service provider responses.

12. The method of claim 11 wherein the deliveries comprise information handling systems.

13. The method of claim 12 wherein automatically resolving the freight claims further comprises:
automatically initiating re-delivery of an information handling system identified as lost by a logistics service provider response; and
automatically precluding re-delivery of an information handling system identified as found by a logistics service provider.

14. The method of claim 13 further comprising:
tracking response times between freight claim communications to logistics service providers and logistics service provider responses; and
assigning a logistics service provider response of lost if a predetermined response time lapses.

15. The method of claim 13 further comprising:
validating freight claim information before sending freight claims to the logistics service provider; and
initiating re-delivery of information handling systems associated with an invalid freight claim.

16. The method of claim 13 further comprising:
tracking payment balance based on the identified freight claims and the logistics service provider responses; and
communicating the payment balances to a financial institution associate with payments to the logistics service provider for the deliveries.

17. The method of claim 16 wherein communicating freight claims and balances further comprises sending EDI messages.

18. A method for manufacturer management of freight claims associated with delivery of build to order products by a logistics service provider, the method comprising:
accepting orders from plural customers for products to be built to a customer-ordered configuration;
building the products;
providing the products to a logistics service provider for delivery of each product to a location associated with a customer;
receiving freight claims from customers for failure of the logistics service provider to deliver products;
automatically communicating the freight claims to the logistics service provider;
receiving responses of the logistics service provider to freight claims;
automatically re-building the products associated with a response of lost or damaged; and
precluding the re-building of products associated with a response of found.

19. The method of claim 18 further comprising:
validating that the location associated with freight claims matches the location provided to the logistics service provider for the products.

20. The method of claim 18 wherein the products comprise information handling systems.
